(19) United States
(12) Patent Application Publication
(10) Pub. No.: US 2004/0185178 A1
(43) Pub. Date: Sep. 23, 2004

(54) Negative static electrically charged coating for glass

(76) Inventor: Leonard D. Rood, Boynton Beach, FL (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 10/393,107

(22) Filed: Mar. 20, 2003

(51) Int. Cl. B05D 3/12

(52) U.S. Cl. 427/355

(57) ABSTRACT

A liquid which has a negative static electrical charge is coated onto positive static electrically charged glass windows, automobile and truck windshields and glass mirrors, causing the surfaces to become negatively charged. Since like static electrical charges will repel each other, the negative static electrically charged liquid coating will repel negative static electrically charged human fibers, dust and other negatively charged particles. The liquid can be coated onto the surface and then rubbed to a thin film by using a paper or fabric sheet or a circular rotating polisher. The liquid can also be pre-coated onto a paper or fabric sheet or a circular rotating polisher and then rubbed onto the surface to produce a thin film. If the film is not thin, the coating will be streaked.

### (e) BACKGROUND OF THE INVENTION

1. Field of the Invention

This invention relates to a means which will convert a positive static electrically charged glass surface to a negative static electrically charged surface so that it will repel human fibers, dust and silica based dirt.

2. Description of the Related Art

House dust contains human negative static electrically charged fibers and other particles. This dust will attach to positive static electrically charged glass windows, mirrors and other glass objects. Typical dust cleaning solutions for glass use water and a surfactant to remove surface dust; however, because the surfaces remain positive static electrically charged, negative static electrically charged dust will recoat the positive static electrically charged substrates.

U.S. Pat. No. 4,511,489 To Requejo, et al issued on Apr. 16, 1985, refers to a cleaning and polishing composition for acrylic plastic substrates, including Plexiglas, Lucite, Lexan and the like. An aqueous dispersion of a fluid silicone oil, such as polydimethyl siloxane, a nonionic or anionic surfactant, such as sodium lauryl sulfate, and a fluorinated organic surface-active compound are mixed with water and is applied to the plastic surface, after which the plastic surface is dried with a paper towel or other device. The amount of silicone applied varies from about 0.5% to 10% by weight of the of the cleaning composition, preferably 1 to 5% by weight, especially preferably about 2% by weight, based on the total composition, on an active basis. The viscosity of the silicone oil varies from 40 to 15,000 centistokes, preferably from 40 to 1000 centistokes and most preferably from 200 to 500 centistokes.

The patent claims that these compositions provide dust repelling, cleaning and polishing, especially suitable for Plexiglass and other acrylic plastic materials. The patent also asserts that this treatment provides a thin lubricating coating on the plastic substrate which causes the treated surface to become smooth, slippery and electrostatically inert, thereby preventing the collection of dust, oil, grime and other soils on the surface.

The fact that the inventor of U.S. Pat. No. 4,511,489 refers to the static electrical nature of the composition of the invention as being inert and antistatic indicates that the composition does not retain a static electrical charge. Referring to the Triboelectricity series, acrylic plastic surfaces such as Lucite do not retain a static electrical charge since they are in the middle of the chart. They retain neither positive static electrical nor negative electrical charges. The antistatic film composition used on the Lucite was electrostatically inert. But must have had some small negative static electrical charge to repel dust for a period of 3 days to 2 weeks. However, it did fail to repel dust after this 2 week period.

In the case of glass windows and mirrors, the positive static electrical charge of the glass is large since glass stands near the top of the positive static electrical portion of the Triboelectric Series chart. It therefore takes a strong negative static electrical charge of the silicone to overcome the strong positive static electrical charge of the glass mirror or window. The cleaning and polishing silicone compositions used in U.S. Pat. No. 4,511,489 were antistatic and inert; thereby they would be too weak to overcome the strong positive static electrical charge of the glass.

Enclosed areas, such as homes and the inside of automobiles, are subjected to dust and human skin fibers, which coat susceptible surfaces. These surfaces, such as glass mirrors, glass windows and the inside glass surfaces of an automobile are static electrically positively charged and will attract negative static electrically charged human fibers and dust. Washing the glass surface with water and detergent mixtures will remove the dust and human fibers, but the cleaned surface will reattract the dust and human fibers because there is a static electrical attraction between the positive static electrically charged surface and the negative static electrically charged human fibers and dust.

The object of the present invention is to provide a strong negative static electrically charged liquid composition which will overcome the strong positive static electrically charge on the glass surface.

Dust may contain fabric fibers, human skin particles, animal dander, microscopic creatures called mites. Bacteria, mold spores, food particles and other debris. The static electrical charge on these particles is negative. These particles and fibers will adhere to positive static electrically charged surfaces. Coating of these surfaces with a strong, thin, negative static electrically charged coating will inhibit the adhesion of these particles to the surface. The coating should be thin because thicker coatings may cause streaking.

Outside dirt is primarily based on silica, which has a negative static electrical charge. Coating a surface such as the outside of a window or the outside of an automobile windshield with a negative static electrically charged coating will also inhibit silica based dirt attachment to the glass.

### (f) BRIEF SUMMARY OF THE INVENTION

The invention is a treatment for a glass surface so that it will repel human fibers, dust and silica based dirt. The treatment method is to apply a thin, negative static electrically charged coating to the surface of the glass. Preferably the coating is applied as a liquid and rubbed to reduce the coating thickness to a thin film. The preferred coatings are silicone and Teflon (fluorinated hydrocarbon polymers).

### (g) BRIEF DESCRIPTION OF THE SEVERAL VIEWS OF THE DRAWINGS

(Not applicable.)

### (h) DETAILED DESCRIPTION OF THE INVENTION

The key to understanding the underlying static electrical basis of dust and human fiber adhesion is to recognize that materials will repel or attract depending on their static electrical charges. Like elements will repel, unlike elements will attract. A method of determining the static electrical charge of dust or human fibers is to rub the flat side of a nylon toothbrush about 50 times on a piece of wool. Then attempt to attract the material with the flat side of the toothbrush. If the material is positive static electrically charged, it will attach to the flat side of the toothbrush. If the material is negative static electrically charged, it will not be attracted.

An alternative procedure is to rub the face of the toothbrush 50 times onto a roll of Teflon tape, after removing the static electrical charge by grounding the toothbrush on metal. After rubbing on the Teflon tape, the human fibers and house dust were attracted to the face of the toothbrush, also indicating that they were negative static electrically charged.

The phenomenon called static electricity occurs when there are an excess of positive (+) or negative (−) charges on an object's surface. This condition is caused by rubbing certain materials together. Static electricity is not caused by rubbing alone. The position of the material in the Triboelectric Series determines how effectively the charges will be exchanged.

In the case of house dust and human fibers, I rubbed the toothbrush 50 times onto a wool cloth. The human fibers and house dust were not attracted to the face of the toothbrush; therefore, they were negative static electrically charged.

Human fibers and dust adhere to solid surfaces like glass mirrors and windows because these adherents are negatively charged and attach to positively charged surfaces. They also adhere to the inside surfaces of an automobile and other surfaces where humans or animals are present. Typically, cleaning fluids to remove these materials contain water in conjunction with surfactants and possibly ammonia to remove these adherents. Human fibers and dust can be removed by neutralizing the negative charges with water and detergents. However, the surfaces from which they were removed remain positively charged and human fibers and dust will reattach.

Addition of a negative static electrically charged liquid coating to the positive static electrically charged glass surface inhibits the dust from reattaching.

Addition of a negative static electrically charged liquid coating to paper or cloth substrates or a circular rotating polisher allows very thin coatings to be applied to the surfaces. Spray application of the negative static electrically charged liquid coating followed by rubbing with a cloth or paper surface or a circular rotating polisher is also possible. The film must be thin to minimize streaking.

Coating of the interior glass surfaces of an automobile or other enclosed areas having positive static electrically charged glass surfaces will benefit from the above invention by reduction in the amount of inside surface dust and fibers. Coating outside positive static electrically charged glass surfaces, which are subjected to the elements of weather, with a negative static electrically charged liquid coating will also be beneficial in repelling dust and dirt which are based on silica. Thus, the coating of the outside surface of an automobile window with a negative static electrically charged liquid will be beneficial in reducing dirt attachment.

The Electrostatic Discharge Association has published a Triboelectric Series in which materials are rated from positive static electrically charged to negative static electrically charged based on static charges after rubbing on a surface. Triboelectricity is the physics of charge generated through friction. Retention of the charge is dependent on the position of the material in the following table. The more positive or negative the material position on the chart, the greater the charge retention. For example, rubbing celluloid on nylon will produce a negative static electrical charge on the celluloid and a positive static electrical charge on the nylon. The farther apart the materials are on the list, the greater the static electrical charge will be and the greater the retention of the static electrical charge.

The list from positive to negative is as follows:

Positive
+
------------
Air
Human Hands
Asbestos
Rabbit's Fur
Glass
Human Hair
Mica
Nylon
Wool
Lead
Cat's Fur
Silk
Aluminum
Paper
Cotton
Steel
Wood
Lucite
Sealing Wax
Amber
Polystyrene
Rubber Balloon
Sulfur
Hard Rubber
Nickel; Copper
Brass, Silver
Gold, Platinum
Acetate, Rayon
Polyester
Celluloid
Polyurethane
Polyethylene
Polypropylene
Vinyl
Silicone
Silica
Teflon
--------------
Negative
−

I have found that the positive static electrostatic charge on glass surfaces can be changed to negative from positive by applying a thin coat of a negative static electrically charged fluid, containing silicone or Teflon. Silicone is a derivative of silicon and has similar static electrical properties as its parent silica. Although, solutions of other negatively charged triboelectric materials such as polyethylene or polypropylene can also be used, silicone fluid produces a very thin, acceptable surface coating which remains negatively charged after application. I have found that pre-coating a paper or cloth surface with the silicone fluid allows easy application of a thin coating of the silicone onto a solid surface. Although the silicone liquid can be sprayed and then wiped, the best films are obtained by using coated paper or cloth wipers.

Although silicone fluid viscosities vary from 5 centistokes to over 100,000 centistokes, the preferred range is 5 centistoke to 50 centistoke in order to reduce streaking of the coating on a glass surface, Viscosities higher than the 50 centistoke may be used, but streaking may be present at higher viscosity levels.

Teflon coating is available as a solution in high volatility solvents which evaporate after spraying on the glass surface. I have used a liquid spray in the form of a Teflon polymer dissolved in high volatility solvents including petroleum naphtha and contained in and sprayed from the nozzle of a pressurized container, commonly known as a spray can. The key, again, is that the Teflon coating be thin enough to inhibit streaking on the glass surface.

An additional advantage is the fact that the negative static electrical charged liquid deposited on the glass surface reduces the need for repeated cleaning of the glass surface. Once cleaned and coated, the glass surface can be kept dirt free by periodic wiping with a paper or cloth surface coated with the negative static electrically charged silicone or Teflon in order to replenish the coating on the glass surface.

### EXAMPLES

### Example 1

The surface of a vertical glass mirror was determined to be electrostatically positively charged by allowing a negatively charged mixture of human fibers and dust to attach to the surface of the mirror in a home. Human fibers and dust which had accumulated onto the surface of the vertical mirror were then removed by spraying a mixture of water and a surfactant onto the surface of the glass followed by drying with a clean paper towel. A polydimethylsiloxane liquid silicone fluid with a viscosity of 5 centistokes was sprayed onto the surface of the vertical mirror. The silicone was rubbed to a thin film by rubbing with a paper towel. A mixture of human fibers and dust were then placed on the coated surface of the mirror. The human fibers and dust mixture did not attach to the mirror. The surface of the mirror was still uncoated with human fibers and dirt after one month.

7.

### Example 2

A polydimethylsiloxane liquid with a viscosity of 50 centistokes was sprayed onto a vertical glass mirror treated in a manner similar to that in Example 1. The film formed was thin and had no streaks. Human fibers and dust did not adhere to the surface of the mirror.

### Example 3

A Teflon spray, containing petroleum naphtha, other volatile solvents and Teflon, was sprayed onto a cloth surface. The coated cloth was then rubbed onto the surface of a vertical mirror after removing human fibers and dust from. The surface using water and a surfactant mixture. Human fibers and dust did not stick to the coated mirror surface.

### Example 4

A silicone coated paper containing polydimethylsiloxane liquid with a viscosity of 8 centistokes was rubbed onto the outside surface of an automobile windshield using a circular rotating polisher and was subjected to outside elements. Rain water droplets adhered to the outside surface of the windshield as small nodules which disappeared after the windshield dried. Dirt coatings were significantly reduced compared with outside automobile windshield surfaces which were not coated with the silicone liquid.

### Example 5

A Teflon spray was sprayed onto the inside surface of an automobile windshield. The coated surface was rubbed with a paper towel to produce a streak free film. Human fibers and dust did not adhere to the inside surface of the window.

### Example 6

A paper towel coated with polydimethylsiloxane liquid with a viscosity of 20 centistokes was rubbed onto the inside surface of an automobile to produce a streak free film. Human fibers and dust did not adhere to the inside surface of the window.

While certain preferred embodiments of the present invention have been disclosed in detail, it is to be understood that various modifications may be adopted without departing from the spirit of the invention or scope of the following claims.

1. A method for treating a glass surface so that it will repel human fibers, dust and silica based dirt, the method comprising: applying a thin, negative static electrically charged coating to the surface of the glass.

2. A method in accordance with claim 1 wherein the coating is applied as a liquid and rubbed to reduce the coating thickness to a thin film.

3. A method in accordance with claim 1 or claim 2 wherein the coating comprises silicone.

4. A method in accordance with claim 1 or claim 2 wherein the coating comprises fluorinated hydrocarbon polymers.

5. A method in accordance with claim 1 or claim 2 wherein the coating comprises a silicone polydimethylsiloxane liquid having a viscosity from about 5 centistokes to 50 centistokes.
